(19) United States
(12) Patent Application Publication
(10) Pub. No.: US 2007/0206683 A1
(43) Pub. Date: Sep. 6, 2007

(54) METHOD FOR OUTPUTTING DIGITAL VIDEO BROADCAST DATA AND DIGITAL VIDEO BROADCAST RECEIVING BOX

(75) Inventor: Chia-Chun Lin, Nantou County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, omitted

(73) Assignee: Sunplus Technology Co., Ltd., Hsinchu (TW)

(21) Appl. No.: 11/681,186

(22) Filed: Mar. 2, 2007

(30) Foreign Application Priority Data
Mar. 6, 2006 (TW) 95107376

(51) Int. Cl. H04N 11/02

(52) U.S. Cl. 375/240.25

(57) ABSTRACT

A method for outputting a digital video broadcast data, applicable in a digital video broadcast receiver with a data buffer, is provided. The method comprises receiving a digital video broadcast data according to an input clock, storing the digital video broadcast data temporarily into the data buffer, outputting the digital video broadcast data temporarily stored in the data buffer according to an output clock, and adjusting the frequency of the output clock dynamically according to the remainder of the digital video broadcast data in the data buffer. The method dynamically adjusts the frequency of the output clock and be able to output the digital contents smoothly without a large number of data buffer memories.

### CROSS-REFERENCE TO RELATED APPLICATION

This application claims the priority benefit of Taiwan application serial no. 95107376, filed on Mar. 6, 2006. All disclosure of the Taiwan application is incorporated herein by reference.

### BACKGROUND OF THE INVENTION

1. Field of Invention

The present invention relates to a method for outputting a digital video broadcast data and a digital video broadcast receiving box, and more particularly, to a method for outputting a digital video broadcast data that is capable of adjusting the frequency of the output clock dynamically, and a digital video broadcast receiving box that is capable of adjusting the frequency of the output clock dynamically.

2. Description of Related Art

Conventional Digital Video Broadcasting (DVB) receiver is used to demodulate a communication signal, and then output the digital content transmitted by the communication signal. Taking the Digital Video Broadcast Terrestrial (DVB-T) for an example, as shown in FIG. 1, the digital contents of MPEG2 transport stream data are always output by way of bursting due to the influences of the communication transmission protection and signal processing.

Referring to FIG. 1, it is a diagram of the transmission and distribution for the data output by way of conventional segment transient mode. In FIG. 1, T_{S} indicates time for transmitting the symbol; T_{U} indicates the time for transmitting the data; and guard interval Δ is 224 μs. However, through this transmitting method, the transient current consumption is relatively high, and the digital video broadcast receiver is required to have an output clock with relatively high frequency, and correspondingly, due to the high frequency of the output clock, the electronic-magnetic interference (EMI) is relatively large.

In addition, there is a conventional circuit used for smoothing the output signal for the digital content, so as to avoid the problem caused by the burst outputting of the digital contents, as shown in FIG. 2. Referring to FIG. 2, it is a circuit diagram of the conventional digital video broadcast receiving box 200, which comprises an antenna 202, a digital video broadcast receiver 204, and a decoder 206. The antenna 202 is used to receive the digital video broadcast signal dvs; the digital video broadcast receiver 204 is coupled to the antenna 202, and is used to receive the digital video broadcast signal dvs via the antenna 202.

The digital video broadcast receiver 204 comprises a data buffer 208. The digital video broadcast receiver 204 generates a digital video broadcast data das according to the digital video broadcast signal dvs, stores the digital video broadcast data das temporarily in the data buffer 208, and then outputs the digital video broadcast data das temporarily stored in the data buffer 208 according to a single clock sclk. The decoder 206 is coupled to the digital video broadcast receiver 204, and is used to receive the digital video broadcast data das output form the digital video broadcast receiver 204, and then generate a video decode signal vds according to the digital video broadcast data das.

However, as for a conventional digital video broadcast receiving box 200 shown in FIG. 2, the method employed for smoothing the output signal for the digital content is converting different input clock rates and output clock rates by using a large number of data buffer memories, which is illustrated below with reference to FIG. 3, FIG. 4, FIG. 5, and FIG. 6.

FIG. 3 is a lookup table 5 of the ETSI EN 300 744 V1.5.1 (2004-06) P.27 from the European Telecommunications Standards Institute (ETSI), FIG. 4 is a lookup table 16 of the ETSI EN 300 744 V1.5.1(2004-06), FIG. 5 is a lookup table 17 of the ETSI EN 300 744 V1.5.1(2004-06)P.27, and FIG. 6 is a diagram of the transmission and distribution of the conventional data output smoothly. Refer to FIG. 3, FIG. 4, FIG. 5, and FIG. 6 together.

As for the above-mentioned conventional method for smoothing the output, taking the DVB-T for an example, according to the ETSI EN 300 744 V1.5.1 of the ETSI (as shown in FIG. 3, FIG. 4, and FIG. 5), under the condition of 8 MHz channels, 8 K mode, Guard Interval ¼, ⅞ Code Rate, Constellation 64 QAM, and non-hierarchical system, the time for transmitting the symbol T_{S} is 1120 μs (as shown in FIG. 3), the time for transmitting the data T_{U} is 896 μs, and the guard interval Δ is 224 μs, and in total 5292/(68×4) packets have been transmitted during this period (one super-frame=68×4 symbols as shown in FIG. 4), which is equal to about 3969 bytes (one packet=204 bytes), and each packet (204 bytes) has 188 significant bytes. Therefore, the effective bytes for each symbol is about 3657.7 (3969×188/204). It is assumed that the symbol data are generated on average during the time of T_{U}, such that the data transmission rate is about 32.66 (3657.7×8/896) million bits per second, and the output rate is about 26.13 (3657.7×8/1120) million bits per second (as shown in FIG. 5). Thus, the required data buffer is about 731.54 (3657.7×224/1120) bytes (as shown in FIG. 6).

As known from FIG. 5, different output clocks with different frequencies are required under different modes, and the output clock is a single clock, such that a large number of data buffer memories and complicated output clock generating circuits are needed to achieve preferred and uniform output.

### SUMMARY OF THE INVENTION

An object of the present invention is to provide a method for outputting a digital video broadcast data, which is mainly used to solve the problem in the conventional art that a large number of data buffer memories and complicated output clock generating circuits are required to smooth the output signal for the digital content.

Another object of the present invention is to provide a digital video broadcast receiving box, which is capable of smoothing the output signal for the digital content without a large number of data buffer memories and complicated output clock generating circuits.

In view of the above and other objects, the present invention provides a method for outputting the digital video broadcast data, applicable in a digital video broadcast receiver with a data buffer. The method comprises receiving the digital video broadcast data according to an input clock, storing the digital video broadcast data in the data buffer temporarily, outputting the digital video broadcast data temporarily stored in the data buffer according to an output clock, and adjusting the frequency of the output clock dynamically according to the remainder of the digital video broadcast data in the data buffer, so as to continuously output the digital video broadcast data.

In view of the above and other objects, the present invention provides a digital video broadcast receiving box, which comprises an antenna, a digital video broadcast receiver, and a decoder. The antenna is used to receive a digital video broadcast signal. The digital video broadcast receiver is coupled to the antenna and used to receive the digital video broadcast signal via the antenna. The digital video broadcast receiver having a data buffer is used to generate a digital video broadcast data according to the digital video broadcast signal, store the data into the data buffer temporarily, output the digital video broadcast data temporarily stored in the data buffer according to the output clock, and adjust the frequencies of the output clock dynamically according to the remainder of the digital video broadcast data in the data buffer, so as to continuously output the digital video broadcast data. The decoder is coupled to the digital video broadcast receiver and used to receive the digital video broadcast data output by the digital video broadcast receiver, and then generate a video decode signal according to the digital video broadcast data.

The digital video broadcast receiving box according to a preferred embodiment of the present invention further comprises a clock generator and a processing circuit. The clock generator is coupled to the data buffer, and is used to output output clocks with different frequencies, and adjust the frequencies of the output clocks dynamically according to a control signal. The processing circuit is coupled to the data buffer and the clock generator, and is used to output a detecting signal for detecting the remainder of the digital video broadcast data in the data buffer, and generate the control signal according to the result of the detecting signal.

As for the method for outputting the digital video broadcast data and the digital video broadcast receiving box according to a preferred embodiment of the present invention, the step of dynamically adjusting the frequencies of the output clock includes adjusting the frequency of the output clock as a first frequency. When the remainder of the digital video broadcast data in the data buffer is more than or equal to the first remainder, adjust the frequency of the output clock as a second frequency. When the remainder of the digital video broadcast data in the data buffer is less than or equal to a second remainder, adjust the frequency of the output clock as the first frequency. The first remainder is greater than the second remainder, the first frequency is less than the second frequency, and the first frequency is less than the frequency of the input clock.

As for the method for outputting the digital video broadcast data and the digital video broadcast receiving box according to a preferred embodiment of the present invention, the step of dynamically adjusting the frequencies of the output clock includes obtaining a lookup table of the corresponding relationship between multiple frequencies and the remainder of the digital video broadcast data in the data buffer, and then finding out the corresponding frequency from the lookup table according to the remainder of the digital video broadcast data in the data buffer, so as to adjust the output clock.

As for the method for outputting the digital video broadcast data and the digital video broadcast receiving box according to a preferred embodiment of the present invention, the step of dynamically adjusting the frequencies of the output clock includes calculating and obtaining the frequency of the output clock according to the equation of CLK=60 MHz/N,
wherein N=(32-INT((Buffer_Remainder-1)/20)),
CLK: frequency of the output clock,
INT( ): function for retrieving the integral part of the input parameter, Buffer_Remainder: remainder of the digital video broadcast data in the data buffer.

The smoothing of the output signal for the digital content is achieved in the present invention by dynamically adjusting the frequencies of the output clock, such that a large number of data buffer memories and complicated output clock generation circuits are not required in the method for outputting the digital video broadcast data and the digital video broadcast receiving box of the present invention.

In order to make the aforementioned and other objects, features and advantages of the present invention comprehensible, preferred embodiments accompanied with figures are described in detail below.

It is to be understood that both the foregoing general description and the following detailed description are exemplary, and are intended to provide further explanation of the invention as claimed.

### BRIEF DESCRIPTION OF THE DRAWINGS

FIG. 1 is a diagram of the transmission and distribution for the data output by means of a conventional segment transient mode.

FIG. 2 is a circuit diagram of a conventional digital video broadcast receiver 200.

FIG. 3 is a lookup table 5 of the ETSI EN 300 744 V1.5.1 (2004-06)P.27 of the ETSI.

FIG. 4 is a lookup table 16 of the ETSI EN 300 744 V1.5.1 (2004-06) of the ETSI.

FIG. 5 is a lookup table 17 of the ETSI EN 300 744 V1.5.1 (2004-06)P.27 of the ETSI.

FIG. 6 is a diagram of the transmission and distribution for the data output by means of the conventional smoothing mode.

FIG. 7 is a flow chart of a method for outputting the digital video broadcast data according to a preferred embodiment of the present invention.

FIG. 8 is a flow chart of the step of dynamically adjusting the frequency of the output clock according to a preferred embodiment of the present invention.

FIG. 9 is a flow chart of the step of obtaining the output clock with the first frequency and the output clock with the second frequency according to a preferred embodiment of the present invention.

FIG. 10 is a flow chart of the step of dynamically adjusting the frequency of the output clock according to another preferred embodiment of the present invention.

FIG. 11 is a circuit diagram of the digital video broadcast receiving box 1100 according to a preferred embodiment of the present invention.

FIG. 12 is a comparison diagram of the possible curves of the changing of the bit rate between the conventional art and the present invention.

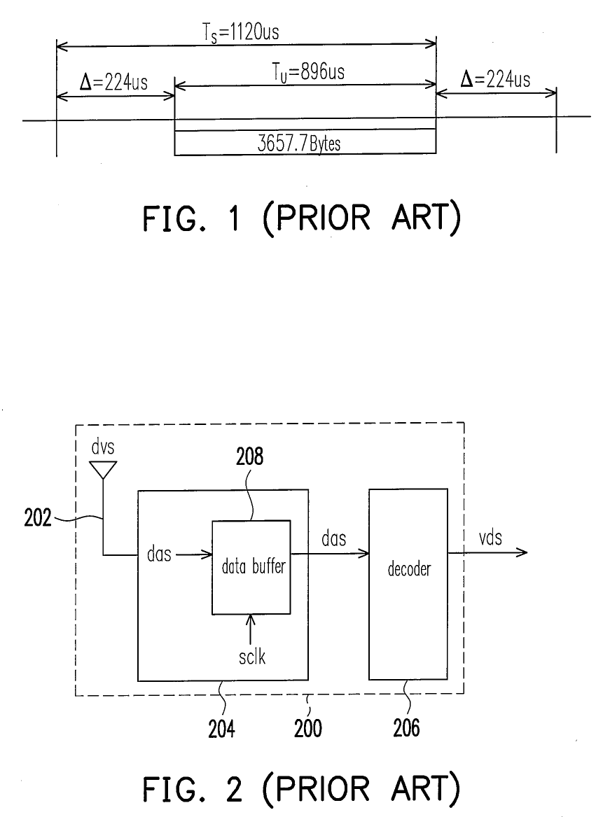

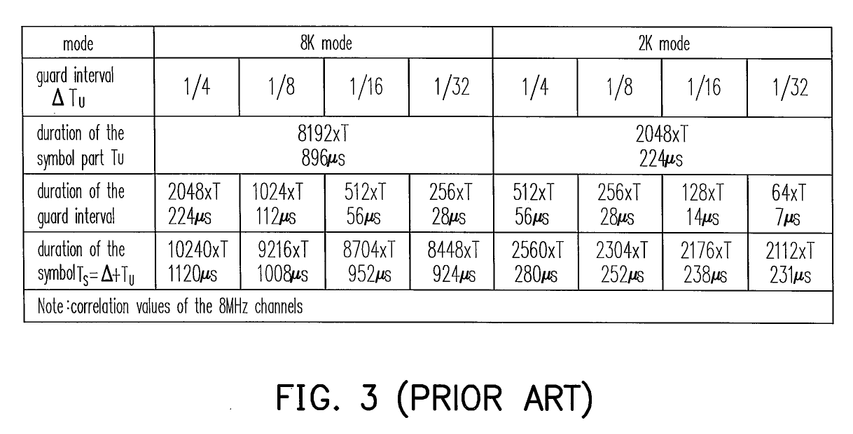

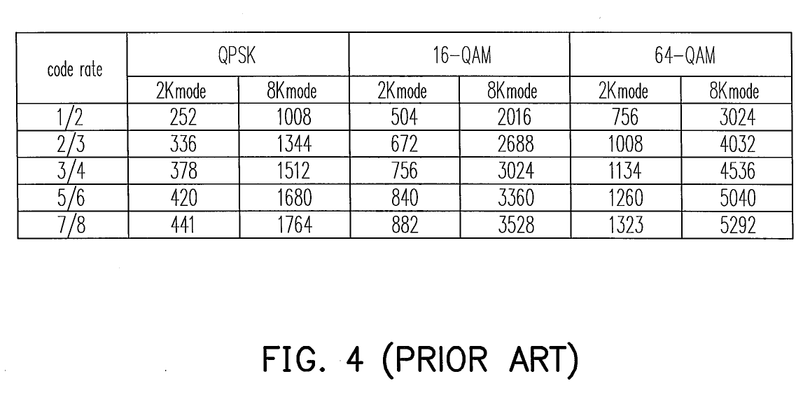

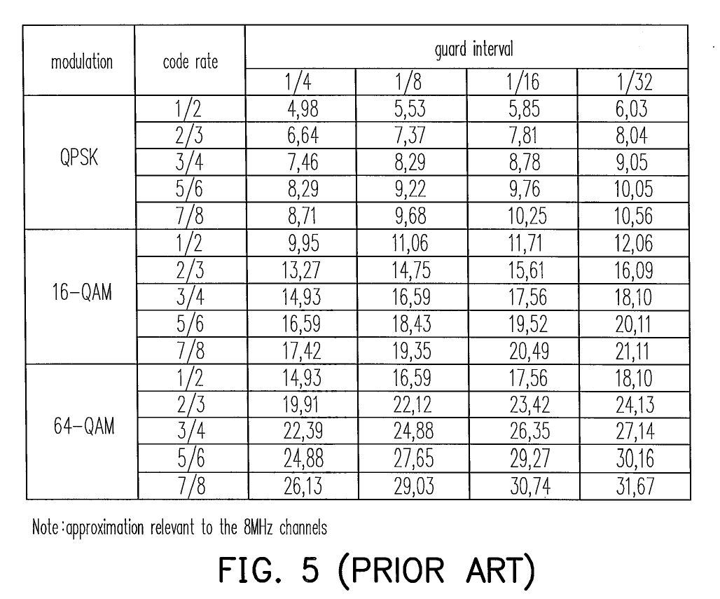

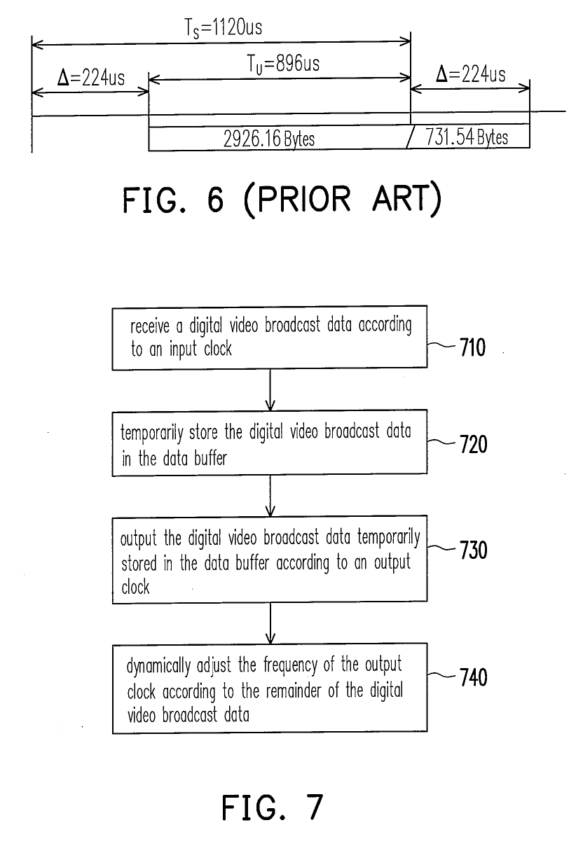

### DESCRIPTION OF EMBODIMENTS

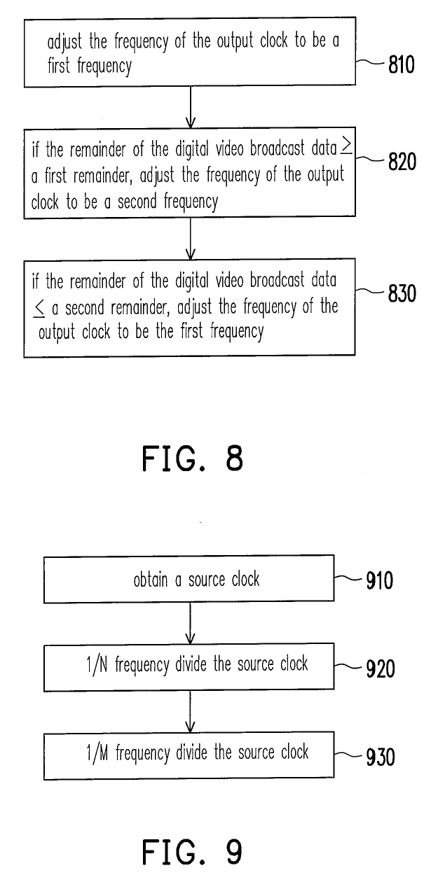

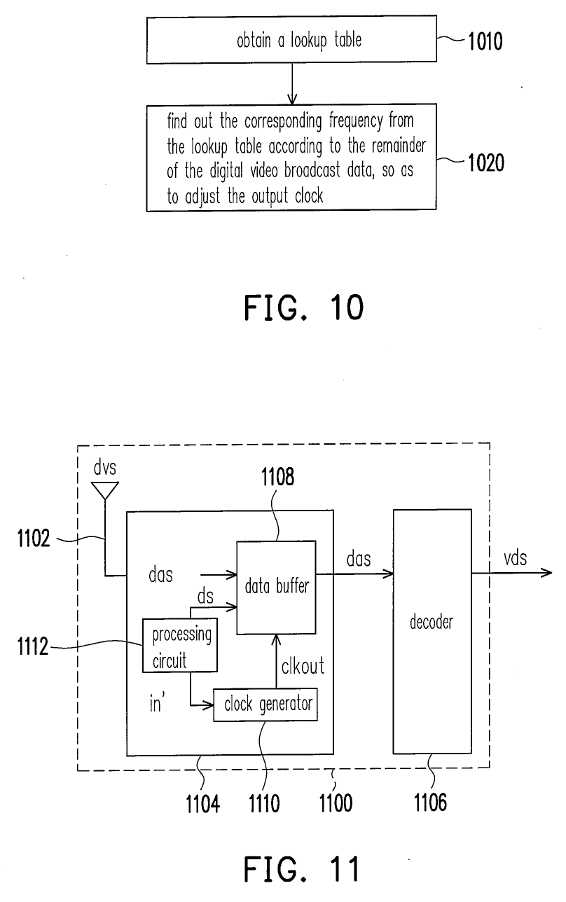

FIG. 7 is a flow chart of a method for outputting a digital video broadcast data according to a preferred embodiment of the present invention. FIG. 8 is a flow chart of the step of dynamically adjusting the frequency of the output clock according to a preferred embodiment of the present invention. FIG. 9 is a flow chart of the step of obtaining the output clock with the first frequency and the output clock with the second frequency according to a preferred embodiment of the present invention. FIG. 10 is a flow chart of the step of dynamically adjusting the frequency of the output clock according to another preferred embodiment of the present invention. The following description is given with reference to FIGS. 7, 8, 9, and 10, and the mentioned figures are referred to according to requirements.

Referring to FIG. 7, the following steps are included: receiving the video broadcast data according to an input clock (Step 710); temporarily storing the digital video broadcast data into the data buffer (Step 720); outputting the digital video broadcast data temporarily stored in the data buffer according to an output clock (Step 730); dynamically adjusting a frequency of the output clock according to the remainder of the digital video broadcast data (Step 740). The step of dynamically adjusting the frequency of the output clock in Step 740 is shown in FIG. 8. The step in FIG. 8 includes adjusting the frequency of the output clock to be a first frequency (Step 810).

If the remainder of the digital video broadcast data in the data buffer is greater than or equal to a first remainder, adjust the frequency of the output clock to be a second frequency (Step 820). If the remainder of the digital video broadcast data in the data buffer is less than or equal to a second remainder, adjust the frequency of the output clock to be the first frequency (Step 830). It should be noted that, the first remainder is larger than the second remainder, the first frequency is smaller than the second frequency, and the first frequency is smaller than the frequency of the input clock.

The above step of obtaining the output clock with the first frequency and obtaining the output clock with the second frequency is shown in FIG. 9. The step in FIG. 9 includes: obtaining a source clock (Step 910), wherein the frequency of the source clock is greater than that of the input clock; 1/N frequency-dividing the source clock to obtain the output clock with the first frequency (Step 920); and 1/M frequency-dividing the source clock to obtain the output clock with the second frequency (Step 930), wherein N and M are natural numbers larger than 1, and N is larger than M.

Take the 8 MHz Channels, 8 K mode, Guard Interval ¼, ⅞ Code Rate, Constellation 64 QAM, non-hierarchical system for example. First of all, the buffer memory is selected to be 600 bytes, the first remainder is 553 bytes, the second remainder is 552 bytes, and the frequency of the input clock is 32.66 MHz. Then, the source clock with a frequency of 64 MHz is 1/N frequency divided, so as to obtain an output clock with a first frequency of 21.33 MHz. Next, the source clock with the frequency of 64 MHZ is 1/M frequency divided, so as to obtain an output clock with a second frequency of 32 MHz. Afterward, the frequency of the output clock is selected to be the first frequency (i.e., the lower frequency), so as to output the digital video broadcast data.

During the period T_{U} for transmitting data, since the frequency of the output clock is the first frequency (i.e., 21.33 MHz), the remainder of the digital video broadcast data in the data buffer is accumulated until it is larger than or equal to the first remainder (i.e., 553 bytes). Then, the frequency of the output clock is changed to the second frequency (i.e., 32 MHz), and at this time, the frequency of the input clock (i.e., 32.66 MHz) is still higher than the second frequency (i.e., 32 MHz) of the output clock. However, the accumulation has already been slowed down when the guard interval Δ (896 μs) begins, and the remainder has been accumulated up to about 597 bytes. Meanwhile, the inputting process has already been stopped, thus the remainder in the data buffer begins to be reduced, and it reduces to 552 bytes at about 905 μs. At this time, the frequency of the output clock is changed into the first frequency (i.e., 21.33 MHz), and the data for one symbol is completely transmitted at about 1112 μs.

However, the method for obtaining the output clock with the first frequency and the output clock with the second frequency is not limited in the present invention, and a user can select several sets of easily-generated source clocks according to the actual requirements, so long as the frequencies of the source clock are within the range between the maximum frequency and the minimum frequency required in the specification. Furthermore, the frequency of the output clock is not limited to the above two kinds, and if the user wants to achieve a more preferred smooth effect, several sets of frequencies between the maximum frequency and the minimum frequency can be selected.

The step of dynamically adjusting the frequency of the output clock can also be achieved through the step shown in FIG. 10. Referring to FIG. 10, a lookup table is obtained (Step 1010), and then, according to the remainder of the digital video broadcast data, the corresponding frequency is found out from the lookup table to adjust the frequency of the output clock (Step 1020). The frequency in the lookup table corresponding to the remainder of the digital video broadcast data is calculated and obtained through the equation CLK=60 MHz/N, wherein N=(32-INT((Buffer_Remainder-1)/20)). In the equation of CLK=60 MHz/N, CLK represents the frequency of the output clock. In the N=(32-INT((Buffer_Remainder-1)/20)), the function INT( ) represents retrieving the integral part of the input parameter; and Buffer_Remainder represents the remainder of the digital video broadcast data in the data buffer. However, the frequency in the lookup table corresponding to the remainder of the digital video broadcast data is not limited to be calculated and obtained through the equation CLK=60 MHz/N, and those skilled in the art can modify the equation for obtaining frequencies according to actual requirements.

In addition, there is another method for dynamically adjusting the frequency of the output clock, that is, the frequency required by the output clock is obtained through the equation CLK=60 MHz/N without using a lookup table, and then, the output clock is adjusted according to the obtained frequency.

For example, take 8 MHz Channels, 8 K mode, Guard Interval ¼, ⅞ Code Rate, Constellation 64 QAM, non-hierarchical system for example. First of all, the data buffer is set to be 640 bytes. Then, the frequency of the output clock is obtained through the equation CLK=60 MHz/N, such that the frequency of the output clock is determined by the remainder of the digital video broadcast data in the data buffer. Thus, when the remainder is 1-20 bytes, the frequency CLK of the output clock is 60/31 (i.e., 1.94 MHz), and when the remainder is 621-640 bytes, the frequency CLK of the output clock is CLK/1 (i.e., 60 MHz).

In view of the above, in this method, the output clock with the slower frequency is used for outputting a digital video broadcast data. Then, the remainder of the digital video broadcast data in the data buffer is gradually increased. Next, as the frequency of the output clock is gradually accelerated, the accumulation of the remainder of the digital video broadcast data in the data buffer is slowed down, and until the frequency of the output clock is higher than that of the input clock, the remainder of the digital video broadcast data in the data buffer begins to reduce. After that, it oscillates up and down about the frequency of the input clock, until the guard interval Δ begins. At this time, the frequency of the input clock is 0, such that the remainder of the digital video broadcast data in the data buffer begins to reduce, and the reducing speed is relatively high at the very beginning. Then, as the remainder decreases, the output clock with the slower frequency is selected, such that the reduction of the remainder of the digital video broadcast data in the data buffer is gradually slowed down, thereby achieving the smoothing effect.

FIG. 11 is a circuit diagram of the digital video broadcast receiving box 1100 according to a preferred embodiment of the present invention. Referring to FIG. 11, the digital video broadcast receiving box 1100 includes an antenna 1102, a digital video broadcast receiver 1104, and a decoder 1106. The antenna 1102 is used to receive the digital video broadcast signal dvs. The digital video broadcast receiver 1104 is coupled to the antenna 1102, for receiving the digital video broadcast signal dvs via the antenna 1102. The digital video broadcast receiver 1104 having a data buffer 1108 is used to generate a digital video broadcast data das according to the digital video broadcast signal dvs, and then temporarily store the data into the data buffer 1108.

The digital video broadcast receiver 1104 outputs the digital video broadcast data das temporarily stored in the data buffer 1108 according to the output clock clkout, and then dynamically adjusts the frequency of the output clock clkout according to the remainder of the digital video broadcast data das in the data buffer 1108, so as to continuously output the digital video broadcast data das. The decoder 1106 is coupled to the digital video broadcast receiver 1104, for receiving the digital video broadcast data das output by the digital video broadcast receiver 1104, and then generating a video decode signal vds according to the digital video broadcast data das.

In the preferred embodiment shown in FIG. 11, the digital video broadcast receiver 1104 further includes a clock generator 1110 and a processing circuit 1112, wherein the clock generator 1110 is coupled to the data buffer 1108, for outputting the output clock clkout with different frequencies. The processing circuit 1112 is used to output a detecting signal ds to the data buffer 1108, for detecting the remainder of the digital video broadcast data das in the data buffer 1108. Besides, the processing circuit 1112 generates a control signal in according to the results of the detecting signal ds, so as to control the clock generator 1110, thereby dynamically adjusting the frequency of the output clock clkout. The step of dynamically adjusting the frequency of the output clock clkout can be achieved through the steps shown in FIGS. 7 and 8, or shown in FIGS. 7, 8, together with FIG. 9, or shown in FIGS. 7 and 10. Alternatively, the frequency of the output clock clkout can be dynamically adjusted through the equation CLK=60 MHz/N, the detailed steps will not be repeated herein.

In addition, the digital video broadcast receiver 1104 employs the lookup table for dynamically adjusting the frequency of the output clock clkout. The user can establish a storage device (not shown in FIG. 11) in the processing circuit 1112 for storing the lookup table. The frequency in the lookup table corresponding to the remainder of the digital video broadcast data can be calculated and obtained through the equation CLK=60 MHz/N.

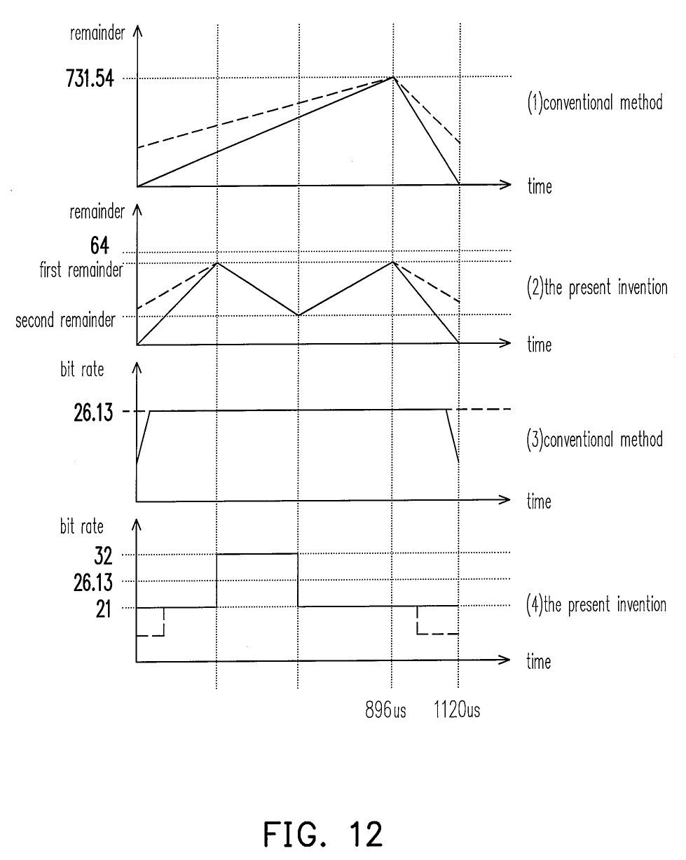

FIG. 12 is a comparison diagram of possible curves of the changing of the bit rate between the conventional art and the present invention. Referring to FIG. 12, the difference between the conventional art and the present invention is indicated by the curves of the possible remainder of the digital video broadcast data to time (shown in the diagrams of (1) and (2) of FIG. 12) and the bit rate to time (shown in the diagrams of (3) and (4) of FIG. 12).

The requirements for the data buffer in the conventional method (shown in the diagrams (1) and (3) of FIG. 12) depends on the output during the guard interval A. Taking the diagram (1) of FIG. 12 as an example, when the time point is at 896 μs, the maximum remainder of the digital video broadcast data occurs. As for the changing of the bit rate, it maintains a relatively stable condition. However, if the rate of the output clock is slightly higher than the average, taking the diagram (3) of FIG. 12 as an example, when the time point is approximately at 0 μs and 1120 μs, the rate lower than the average occurs. Alternatively, if the output clock is much larger than the average rate, the sudden drop of the bit rate may occur at any time point. As for the present invention, the requirements of the data buffer depend on the cooperation of the first remainder and the second remainder at the same time point. Seen from the diagram (2) of FIG. 12, the usage of the data buffer is dynamically changed, unlike the conventional method that it is gradually increased or decreased. Seen from the diagram (4) of FIG. 12, the changing of the bit rate is oscillated about the average bit rate. However, the oscillation is not severe.

To sum up, the output signal for the digital content is smoothened in the present invention by dynamically adjusting the frequency of the output clock, such that a large number of data buffer memories and complicated output clock generating circuits are not required in the method for outputting the digital video broadcast data and the digital video broadcast receiving box of the present invention. Besides, since the output signal for the digital content has already been smoothened, there is a relatively large space for the subsequent processors. Taking DVB-T for an example, the decoder 1106 (decoder 1106 is referred to as MPEG2Decoder) following the digital video broadcast receiver 1104 is used to process the received digital content without the output clock with an excessively high frequency.

Though the present invention has been disclosed above by the preferred embodiments, they are not intended to limit the invention. Anybody skilled in the art can make some modifications and variations without departing from the spirit and scope of the invention. Therefore, the protecting range of the invention falls in the appended claims.

What is claimed is:

1. A method for outputting digital video broadcast data, applicable in a digital video broadcast receiver having a data buffer, comprising:
receiving the digital video broadcast data according to an input clock;
temporarily storing the digital video broadcast data into the data buffer;
outputting the digital video broadcast data stored in the data buffer according to an output clock; and
adjusting the frequency of the output clock according to a remainder of the digital video broadcast data in the data buffer, so as to continuously output the digital video broadcast data, further comprising:
adjusting the frequency of the output clock to be a first frequency;
when the remainder of the digital video broadcast data in the data buffer is greater than or equal to a first remainder, adjusting the frequency of the output clock to be a second frequency; and
when the remainder of the digital video broadcast data in the data buffer is less than or equal to a second remainder, adjusting the frequency of the output clock to be the first frequency;
wherein the first remainder is greater than the second remainder, and the first frequency is less than the second frequency.

2. The method for outputting the digital video broadcast data as claimed in claim 1, wherein the first frequency is less than the frequency of the input clock.

3. The method for outputting the digital video broadcast data as claimed in claim 1, wherein the first frequency or the second frequency for the output clock is obtained through the following steps:
obtaining a source clock, wherein the frequency of the source clock is greater than that of the input clock; and
obtaining an output clock with the first frequency by 1/N frequency-dividing the source clock; and
obtaining an output clock with the second frequency by 1/M frequency-dividing the source clock,
wherein N and M are natural numbers larger than 1, and N is larger than M.

4. The method for outputting the digital video broadcast data as claimed in claim 1, wherein the method for dynamically adjusting the frequency of the output clock comprises calculating and obtaining the frequency of the output clock according to the equation CLK=60 MHz/N, wherein N=(32-INT((Buffer_Remainder-1)/20)), CLK represents frequency of the output clock, INT( ) represents function for retrieving the integral part of the input parameter, and Buffer_Remainder represents remainder of the digital video broadcast data in the data buffer.

5. A method for outputting digital video broadcast data, applicable to a digital video broadcast receiver having a data buffer, comprising:
receiving the digital video broadcast data according to an input clock;
temporarily storing the digital video broadcast data into the data buffer;
outputting the digital video broadcast data stored in the data buffer according to an output clock;
adjusting the frequency of the output clock according to the remainder of the digital video broadcast data in the data buffer, so as to continuously output the digital video broadcast data, further comprising:
obtaining a lookup table; and
finding out the corresponding frequency from the lookup table according to the remainder of the digital video broadcast data in the data buffer, so as to adjust the output clock.

6. The method for outputting the digital video broadcast data as claimed in claim 5, wherein the frequency in the lookup table corresponding to the remainder of the digital video broadcast data is calculated and obtained through the equation CLK=60 MHz/N, wherein N=(32-INT((Buffer_Remainder-1)/20)), CLK represents frequency of the output clock, INT( ) represents function for retrieving the integral part of the input parameter, and Buffer_Remainder represents remainder of the digital video broadcast data in the data buffer.

7. A digital video broadcast receiving box, comprising:
an antenna, for receiving a digital video broadcast signal;
a digital video broadcast receiver, coupled to the antenna, having a data buffer is used to store a digital video broadcast data according to the digital video broadcast signal, outputting the digital video broadcast data temporarily stored in the data buffer according to an output clock, and adjusting the frequency of the output clock according to the remainder of the digital video broadcast data in the data buffer, so as to continuously output the digital video broadcast data; and
a decoder, coupled to the digital video broadcast receiver, for generating a video decode signal according to the digital video broadcast data.

8. The digital video broadcast receiving box as claimed in claim 7, wherein the digital video broadcast receiver further comprises:
a clock generator, coupled to the data buffer, for outputting the output clock with different frequencies, and adjusting the frequency of the output clock according to a control signal;
a processing circuit, coupled to the data buffer and the clock generator, for outputting a detecting signal for detecting the remainder of the digital video broadcast data in the data buffer, and generating the control signal according to the result of the detecting signal.

9. The digital video broadcast receiving box as claimed in claim 8, wherein when the digital video broadcast receiver adjusts the frequency of the output clock, the frequency of the output clock is firstly adjusted to be a first frequency; if the remainder of the digital video broadcast data in the data buffer is greater than or equal to a first remainder, the frequency of the output clock is adjusted to be a second frequency; and if the remainder of the digital video broadcast data in the data buffer is less than or equal to a second remainder, the frequency of the output clock is adjusted to be the first frequency; wherein the first remainder is larger than the second remainder, and the first frequency is smaller than the second frequency.

10. The digital video broadcast receiving box as claimed in claim 8, wherein when the digital video broadcast receiver adjusts the frequency of the output clock, a lookup table is firstly obtained, and the corresponding frequency is found out from the lookup table, so as to adjust the output clock.

11. The digital video broadcast receiving box as claimed in claim 8, wherein when the digital video broadcast receiver adjusts the frequency of the output clock, the frequency of the output clock is obtained through the equation CLK=60 MHz/N, wherein N=(32-INT((Buffer_Remainder-1)/20)), CLK represents frequency of the output clock, INT( ) represents function for retrieving the integral part of the input parameter, and Buffer_Remainder represents remainder of the digital video broadcast data in the data buffer.

12. The digital video broadcast receiving box as claimed in claim 10, wherein the frequencies in the lookup table corresponding to the remainder of the digital video broadcast data is calculated and obtained through the equation CLK=60 MHz/N, wherein N=(32-INT((Buffer_Remainder-1)/20)), CLK represents frequency of the output clock, INT( ) represents function for retrieving the integral part of the input parameter, and Buffer_Remainder represents remainder of the digital video broadcast data in the data buffer.
